(19) United States
(12) Patent Application Publication
(10) Pub. No.: US 2024/0210092 A1
(43) Pub. Date: Jun. 27, 2024

(54) AIR DUCT ASSEMBLY AND REFRIGERATING APPLIANCE HAVING THE SAME

(71) Applicants: QINGDAO HAIER SPECIAL REFRIGERATION ELECTRIC APPLIANCE CO., LTD., Qingdao, Shandong (CN); QINGDAO HAIER REFRIGERATOR CO., LTD, Qingdao, Shandong (CN); HAIER SMART HOME CO., LTD., Qingdao, Shandong (CN)

(72) Inventors: Yanbin WAN, Qingdao, Shandong (CN); Jianquan CHEN, Qingdao, Shandong (CN); Shaoyi WANG, Qingdao, Shandong (CN); Peng LV, Qingdao, Shandong (CN)

(21) Appl. No.: 18/557,728

(22) PCT Filed: Jan. 14, 2022
(86) PCT No.: PCT/CN2022/071991

§ 371 Date: Oct. 27, 2023

(30) Foreign Application Priority Data
Apr. 30, 2021 (CN) 202120938942.X

(51) Int. Cl. F25D 17/06; G10K 11/16

(52) U.S. Cl. CPC F25D 17/065; G10K 11/161; F25D 2317/067

(57) ABSTRACT

The present utility model discloses a compressor bin and a refrigeration apparatus having the same; when a sound in the compressor bin reaches a silencing channel of a silencing device along an air supply channel, the sound enters a silencing cavity, which prolongs a propagation path of the sound, reduces energy of the sound, and reduces the continuously emitted sound, such that a noise generated by the refrigerator is reduced, normal venting and heat dissipation in the compressor bin are not influenced, and a good noise reduction effect is achieved while normal operation of the refrigerator is guaranteed.

### TECHNICAL FIELD

The present utility model relates to an air duct assembly and a refrigeration apparatus having the same, and pertains to the field of household appliance technologies.

### BACKGROUND

A refrigerator may generate noises during working, and especially in a working process of an air-cooled refrigerator, when cold air circulates in the refrigerator, air flow moves in an air duct to generate wind noises, and especially when the air flow passes through some spaces with small cross-sectional areas or the air flow has a high flow speed at some positions, sharper noises may be generated; in addition, the noise is essentially a vibration, and therefore, the noise also can be transmitted more favorably with the flowing of the air flow, the vibration of the air flow carries a sound wave of the noise, but in an existing refrigerator, this noise is usually neglected, such that a user has an intuitive feeling that the refrigerator generates a large noise in use, thus influencing use experiences of the user.

### SUMMARY

In order to solve a problem in a prior art, an object of the present utility model is to provide an air duct assembly and a refrigerating appliance having the same.

To achieve the above object of the utility model, an embodiment of the present utility model provides an air duct assembly, comprising an air flow passage, wherein the air duct assembly further comprises a silencing device provided on the air flow passage, the silencing device comprises a silencing body, a silencing channel penetrating through the silencing body and a plurality of silencing cavities arranged in the silencing body, the silencing channel is communicated with the air flow passage, and the silencing cavity comprises an opening facing the silencing channel.

As a further improvement of the present utility model, the air flow passage comprises an air inlet, an air duct and an air outlet, and the silencing device is provided at the air inlet, and/or in the air duct, and/or at the air outlet.

As a further improvement of the present utility model, an upstream position and a downstream position of the silencing device are formed along an air circulation direction, and parts of the air flow passage upstream and downstream of the silencing device are communicated only through the silencing channel.

As a further improvement of the present utility model, further comprising an air duct bottom plate and an air duct cover plate, wherein the air duct is formed between the air duct bottom plate and the air duct cover plate, and a cross sectional area of the air duct is gradually increased in a direction from the air inlet towards the air duct.

As a further improvement of the present utility model, the silencing channel comprises ports formed on two sides of the silencing body, and the air duct assembly further comprises a protective net provided on at least one of the ports.

As a further improvement of the present utility model, the silencing device comprises a plurality of side walls enclosing the silencing channel, and each of the side walls is provided with a plurality of openings with different areas.

As a further improvement of the present utility model, at least two of the silencing cavities have different volumes.

As a further improvement of the present utility model, the silencing cavity is provided in a labyrinth shape.

To achieve the above object of the utility model, an embodiment of the present utility model provides a refrigerating appliance, comprising the above air duct assembly.

As a further improvement of the present utility model, comprising a refrigerating chamber, a freezing chamber and an evaporator chamber, wherein the air duct assembly is provided in the refrigerating chamber or the freezing chamber, and the silencing channel is communicated with the evaporator chamber.

Compared with the prior art, the present utility model has the following beneficial effects: when air flow flows to an air inlet and passes through a silencing channel of a silencing device, a sound is transmitted into a silencing cavity through an opening, which prolongs a propagation path of the sound, reduces energy of the sound, and reduces the continuously emitted sound, such that a noise generated with the flowing of the air flow or a noise entrained in the air flow is reduced, air supply to an air duct is not influenced, a good noise reduction effect is achieved while a refrigerator continues to operate normally, and use experiences of a user are improved.

### BRIEF DESCRIPTION OF THE DRAWINGS

FIG. 1 is a schematic structural diagram of an air duct assembly according to an embodiment of the present utility model;

FIG. 2 is a sectional view of the air duct assembly with an air duct cover plate removed according to the embodiment of the present utility model;

FIG. 3 is a sectional view of an air duct assembly with an air duct cover plate removed according to another embodiment of the present utility model;

FIG. 4 is a schematic structural diagram of a silencing device in the embodiment of the present utility model; and

FIG. 5 is a sectional view of the silencing device in the embodiment of the present utility model.

In the drawings, 100. air duct assembly; 10. air duct; 20. air inlet; 30. air outlet; 1. silencing device; 11. silencing body; 12. silencing channel; 13. silencing cavity; 131. opening; 14. protective net; 2. air duct bottom plate; 3. air duct cover plate.

### DETAILED DESCRIPTION

Hereinafter, the present utility model will be described in detail in conjunction with specific embodiments shown in the accompanying drawings. However, these embodiments have no limitations on the present utility model, and any transformations of structure, method, or function made by persons skilled in the art according to these embodiments fall within the protection scope of the present utility model.

It should be understood that the terms expressive of spatial relative positions, such as “upper”, “above”, “lower”, “below”, or the like herein are used to describe the relationship of a unit or feature relative to another unit or feature in the drawings, for illustration and description. Terms expressive of the spatial relative positions are intended to include different orientations of the device in use or operation other than the orientations shown in the drawings.

An embodiment of the present utility model provides an air duct assembly and a refrigerating appliance having the same; by improving a structure of the air duct assembly, noises emitted by the refrigerating appliance outwards are reduced, thus protecting an environment around the refrigerating appliance, and improving use experiences of a user.

The refrigeration apparatus according to the present embodiment can be configured as a refrigerator, in particular to a refrigerator with an air cooling refrigeration mode, a refrigeration system is provided in the refrigerator, the refrigeration system has a circulation loop for circulating a refrigerant, the refrigeration system includes a compressor, a condenser, a throttling pipeline and an evaporator connected in series in sequence, the refrigerator further includes a refrigerating chamber, a freezing chamber and an evaporator chamber, the evaporator chamber is provided therein with an evaporator for generating cold air, and a fan blows air flow to an air duct 10 of the air duct assembly 100 through the evaporator chamber and then to the refrigerating chamber or the freezing chamber.

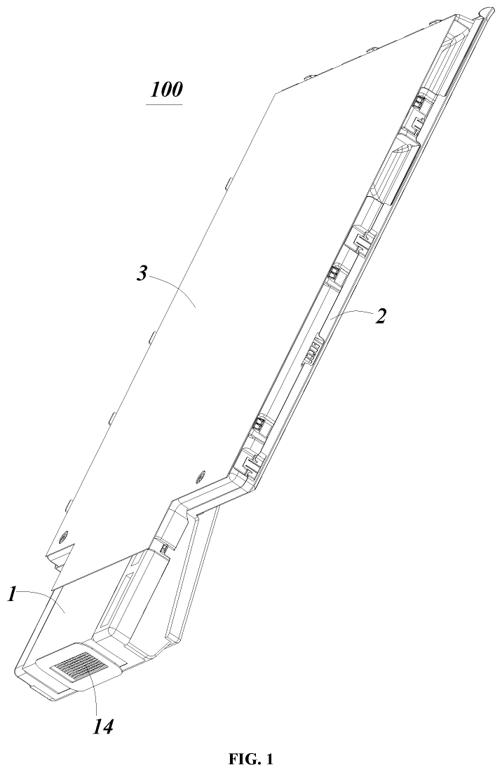

The refrigerator further includes the air duct assembly 100, the air duct assembly 100 includes an air flow passage, the air flow passage includes an air inlet 20, the air duct 10 and an air outlet 30, and the cold air is blown to the air duct 10 from the air inlet 20 and then blown out to a refrigerating compartment through the air outlet 30, as shown in FIGS. 1 to 3.

The present embodiment is mainly used for weakening wind noises in the air duct 10, such that the user has holistic perception of the refrigerator that the refrigerator generates small noises, and a noise problem in a prior art is solved.

To clearly express the position and direction described in the present embodiment, in the present embodiment, the up-down direction can be defined by substantially referring to the direction of gravity when the refrigerator is placed on a horizontal floor, and the position of the air duct assembly 100 with respect to a refrigerator door serves as the rear, whereas the refrigerator door is located in front of the refrigerating chamber or freezing chamber, and the two sides perpendicular to the front-rear direction serve as the left and right.

### First Embodiment

An air duct assembly 100 according to the present embodiment includes an air duct 10, an air inlet 20 for supplying air to the air duct 10 and a silencing device 1 formed at the air inlet 20; the silencing device 1 includes a silencing body 11, a silencing channel 12 penetrating through the silencing body 11 and a plurality of silencing cavities 13 arranged in the silencing body 11, the silencing channel 12 is communicated with the air duct 10, and the silencing cavity 13 includes an opening 131 facing the silencing channel 12, as shown in FIGS. 1 to 5.

The air duct assembly 100 is provided in the refrigerating chamber or the freezing chamber, the silencing channel 12 is communicated with the evaporator chamber, and in the present embodiment, the air duct assembly 100 is especially provided in the refrigerating chamber, the air flow passes through the evaporator chamber, is then blown towards the air inlet 20, and is then blown towards the air duct 10 through the silencing channel 12 of the silencing body 11, the air duct assembly 100 includes air outlets, and the air flow is evenly blown towards the air outlets under flow dividing and rectifying effects of the air duct 10.

The air duct assembly 100 generally includes the plurality of air outlets arranged behind the refrigerating chamber and sequentially provided from top to bottom, such that the air duct assembly 100 generally has a flat structure, as shown in FIGS. 1 to 3, with an object of evenly blowing the air flow out from a whole plane; in a process that the air flow blown out of the evaporator chamber reaches the air inlet 20, a shape of a cross section of an air duct pipe obviously has a great difference from a shape of the air duct 10 in the air duct assembly 100, such that a circulation manner of the air flow at the air inlet 20 suddenly changes, which includes sudden changes in a flow speed and a flow direction; a cross sectional area at the air inlet 20 is smaller than a cross sectional area of the air duct 10, and the air flow speed at this position is high, such that the wind noises and even resonance are often generated at the air inlet 20, and the user externally has an intuitive feeling of the refrigerator that the refrigerator generates a buzz.

In the present embodiment, the silencing device 1 is provided at the air inlet 20 where the air flow speed and direction suddenly change, and configured to reduce the noise generated at this position, thus changing an air flow vibration frequency at this position, avoiding the resonance and achieving a good noise reduction effect.

Further, the air duct assembly 100 includes an accommodating space formed at the air inlet 20, the silencing device 1 is fixed in the accommodating space, and a buffer part may be provided in the accommodating space; for example, a vibration reduction surface, a vibration reduction sealing strip, or the like, may be laid in the accommodating space to avoid the vibration of a silencing structure, and the accommodating space is provided for accurately and stably fixing the silencing structure.

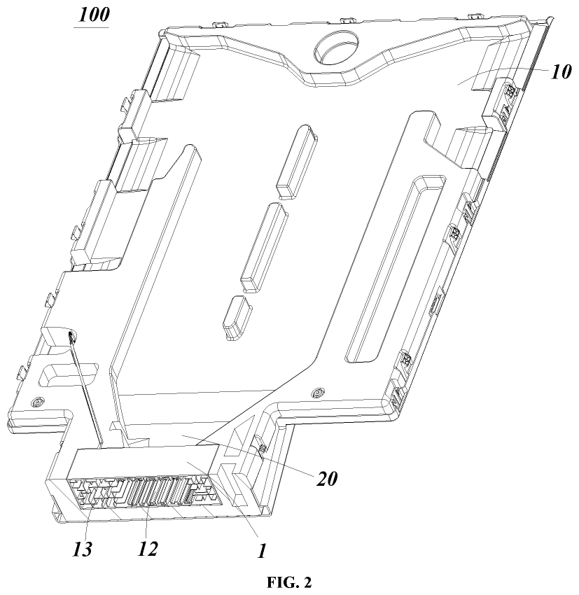

The air duct assembly 100 further includes an air duct bottom plate 2 and an air duct cover plate 3, as shown in FIG. 1 or 2; the air duct 10 is formed between the air duct bottom plate 2 and the air duct cover plate 3, and the cross sectional area of the air duct 10 is gradually increased in a direction from the air inlet 20 to the air duct 10, so as to slow down the sudden changes of the air flow direction and speed, thus reducing the noise generated here.

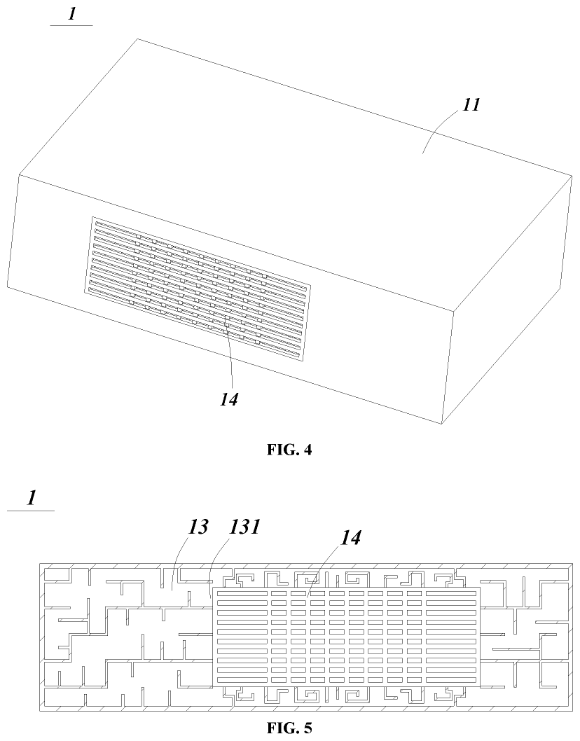

Further, the silencing channel 12 includes ports formed on two sides of the silencing body 11, and the air duct assembly 100 further includes a protective net 14 provided on at least one port, as shown in FIG. 1 or 4, so as to prevent mixed impurities in the air flow from being blown into the silencing cavity 13; more importantly, the protective net 14 has a plurality of small holes, and after sounds pass through the protective net 14, especially high-frequency parts of the sounds hardly pass through the protective net 14; that is, some high-frequency noises are canceled, and the noises are separated by the plural small holes when passing through the net, which is more favorable for noise reduction. A part with a frequency lower than a high frequency is eliminated by the silencing cavity 13, thus eliminating the high-frequency and low-frequency noises. The high-frequency noise eliminated in the present embodiment has a frequency of approximately 1,000 hz or more.

The silencing device 1 is configured to have a cubic structure, and the silencing channel 12 penetrates through the silencing body 11 in a direction from the air inlet 20 to the air duct 10, as shown in FIGS. 1 to 4, thus facilitating generation of the accommodating space, fixation of the silencing device 1 and formation of the arrangement of the silencing channel 12 and the internal silencing cavity 13.

Further, the silencing device 1 includes a plurality of side walls enclosing the silencing channel 12, each side wall is provided with a plurality of openings 131 with different areas, and a propagation path is lengthened when the sound passes through through holes, thus reducing energy of the sound radiated outwards, and achieving the noise reduction effect; a volume of the silencing cavity 13 can determine a frequency range of the sound capable of being eliminated by the silencing cavity 13, different silencing cavities 13 have different silencing frequency ranges, and therefore, by adjusting the volumes of different silencing cavities 13, the noises with different frequencies may be eliminated when the sound enters different silencing cavities 13, such that the silencing device 1 has wider silencing frequencies. At least two silencing cavities 13 have different volumes, such that noise reduction of the sounds with different wavelengths transmitted to various directions is realized while the air flow passes through the silencing device 1, noise reduction of the sounds with different frequencies and wavelengths is realized, and after the sounds pass through the plurality of different openings 131, noise reduction of the sounds with wider frequencies is realized.

Further, the silencing cavity 13 is provided in a labyrinth shape, as shown in FIG. 2 or 5, such that the sound is further propagated to the interior after entering the silencing cavity 13, a large part of the sound cannot be reflected out, and therefore, the sound cannot leave the silencing device 1 to be emitted to the outside after entering the silencing cavity 13, thus further improving a silencing effect thereof. Compared with the prior art, the present embodiment has the following beneficial effects:

When air flow flows to an air inlet and passes through a silencing channel of a silencing device, a sound is transmitted into a silencing cavity through an opening, which prolongs a propagation path of the sound, reduces energy of the sound, and reduces the continuously emitted sound, such that a noise generated with the flowing of the air flow or a noise entrained in the air flow is reduced, air supply to an air duct is not influenced, a good noise reduction effect is achieved while a refrigerator continues to operate normally, and use experiences of a user are improved.

### Second Embodiment

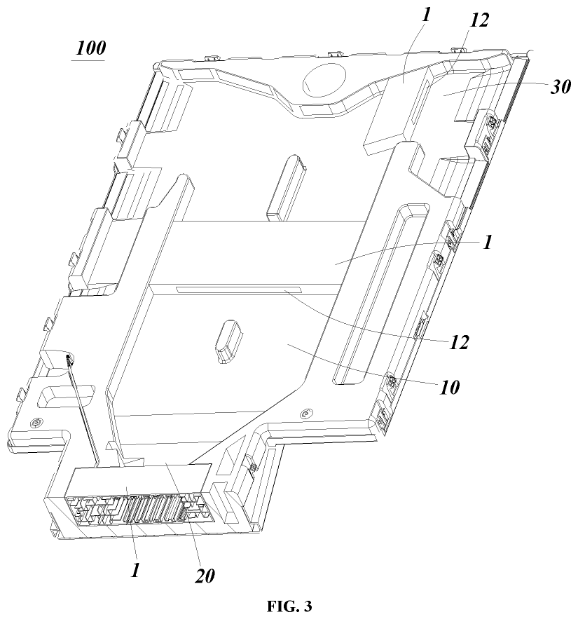

Unlike the first embodiment in which the silencing device is provided at the air inlet 20, the silencing device in the present embodiment may be provided at any position or a plurality of positions on an air flow channel, as shown in FIG. 3.

The silencing device 1 may also be provided in the air duct 10 of the air flow channel or at the air outlet 30, such that the silencing device may be mounted at any position, thus achieving a better noise reduction effect.

In addition, an upstream position and a downstream position of the silencing device 1 are formed along the air circulation direction, and parts of the air flow passage upstream and downstream of the silencing device 1 are communicated only through the silencing channel 12, so as to ensure that the cold air completely passes through the silencing channel 12 as much as possible, thus achieving a more sufficient noise reduction effect.

It should be understood that although the present specification is described based on embodiments, not every embodiment contains only one independent technical solution. Such a narration way of the present specification is only for the sake of clarity. Those skilled in the art should take the present specification as an entirety. The technical solutions in the respective embodiments may be combined properly to form other embodiments which may be understood by those skilled in the art.

A series of the detailed descriptions set forth above is merely specific description of feasible embodiments of the present utility model, and is not intended to limit the protection scope of the present utility model. Equivalent embodiments or modifications made within the spirit of the present utility model shall fall within the protection scope of the present utility model.

What is claimed is:

1. A compressor bin, comprising an inner wall enclosing an air supply channel, wherein the compressor bin further comprises a silencing device, and the silencing device comprises a silencing body, a silencing channel penetrating through the silencing body and a plurality of silencing cavities arranged in the silencing body; a plurality of silencing devices abutting against the inner wall are arranged along an extending direction of the air supply channel, the silencing channel is communicated with the air supply channels on two sides of the silencing device, and the silencing cavity comprises an opening facing the silencing channel.

2. The compressor bin according to claim 1, wherein the silencing device is hermetically connected with a circumference of the inner wall along a vertical plane perpendicular to the extending direction of the air supply channel;
the air supply channel is arranged in a left-right direction, the compressor bin comprises side walls arranged on a left side and a right side, and vents are arranged on the side walls.

3. The compressor bin according to claim 2, wherein ports for passing air flow are provided on two sides of the silencing channel, and the ports are flush with the vents.

4. The compressor bin according to claim 2, wherein the compressor bin comprises a fan and at least one silencing device is provided between the fan and the vent adjacent to the fan.

5. The compressor bin according to claim 4, wherein the fan is configured as an axial flow fan, ports for passing air flow are provided on two sides of the silencing channel, and an extending direction of an axis of the axial flow fan passes through the ports.

6. The compressor bin according to claim 2, wherein the compressor bin comprises a compressor, and at least one silencing device is provided between the compressor and the vent adjacent to the compressor.

7. The compressor bin according to claim 2, wherein the silencing device further comprises a hermetical connection layer provided between the silencing body and the inner wall.

8. The compressor bin according to claim 1, wherein the silencing device comprises a silencing pedestal for heightening the silencing body, the compressor bin comprises a support bottom plate, the silencing pedestal is fixed to the support bottom plate, and the silencing body is fixed to the silencing pedestal;
the silencing pedestal is slidably inserted into the support bottom plate.

9. The compressor bin according to claim 1, wherein at least two of the silencing cavities have different volumes.

10. A refrigeration apparatus, comprising the compressor bin according to claim 1.
